(19) United States
(12) Patent Application Publication
(10) Pub. No.: US 2012/0229974 A1
(43) Pub. Date: Sep. 13, 2012

(54) TABLET PERSONAL COMPUTER

(76) Inventor: Shao-Chieh TING, Banchiau City (TW)

(21) Appl. No.: 13/044,067

(22) Filed: Mar. 9, 2011

(51) Int. Cl. G06F 1/16

(52) U.S. Cl. 361/679.56

(57) ABSTRACT

A bottom of a wide side of a tablet personal computer is provided with external interface slots that when using the tablet personal computer, a user can insert the tablet personal computer horizontally on a dock base, which improves a trouble that interface wires and an audio wire need to be used while using a conventional tablet personal computer horizontally to watch a movie.

### BACKGROUND OF THE INVENTION

a) Field of the Invention

The present invention relates to a tablet personal computer, and more particularly to a tablet personal computer wherein external interface slots are provided at a bottom of a wide side of the tablet personal computer, such that when watching a movie, a user can put the tablet personal computer horizontally on a dock base on a desktop, thereby increasing convenience and aesthetics while using the tablet personal computer.

b) Description of the Prior Art

The mechanism of an existing tablet personal computer is extended from the mechanism of a mobile phone. A bottom of a narrow side of the mobile phone is provided with an external interface slot which can be inserted on a socket generally called a dock to achieve outward transmission of an audio source, a power source and a signal of the mobile phone.

When the existing tablet personal computer is held by hands wirelessly, as there are no connection wires (an audio source, a power source and an image source), the user can hold by hands the tablet personal computer vertically or horizontally, which is extremely convenient when using the tablet personal computer temporarily. However, as the tablet personal computer has a certain weight, the user will feel that it is too heavy when holding it by hands for a long time. Therefore, most users will put the tablet personal computer in the socket that is generally called the dock, allowing the tablet personal computer to be connected to a power source for charging through the dock base, while using the tablet personal computer. If the tablet personal computer is used as an e-book, then speakers in the tablet personal computer will be enough to meet a required audio effect and an externally connected stereo speaker on the dock base will not be of much use.

The existing tablet personal computer can be only inserted vertically on the dock base and there will be three major troubles when putting the tablet personal computer horizontally to watch a movie:

(1) Another bracket for putting the tablet personal computer horizontally should be purchased.

(2) When watching a movie, a better externally connected stereo speaker should be connected and speaker wires should be connected to the tablet personal computer that the wires are suspended in air to affect an appearance.

(3) As it will take a longer time to play the movie, the tablet personal computer should be supplied directly with power and should be recharged. At this time, a power line should be connected to the tablet personal computer that the wire will be suspended in air to affect the appearance.

Referring to FIG. 5, it shows a three-dimensional schematic view of a conventional tablet personal computer 11 which is put horizontally on a sliding base. When connecting with external equipment, the conventional tablet personal computer 11 should be connected through interface transmission wires 80, 90 that the transmission wires are suspended in air, which not only affects the aesthetics but also endangers safety.

Accordingly, to solve the aforementioned issues, a tablet personal computer is created by the present inventor.

### SUMMARY OF THE INVENTION

The primary object of the present invention is to provide a tablet personal computer wherein external interface slots are changed from a bottom of a narrow side to a bottom of a wide side, such that the tablet personal computer can be inserted on a dock base horizontally, an audio wire and a power line can be connected outward from the dock base without complicated wiring; therefore, it will be very convenient to take out or insert the tablet personal computer.

Another object of the present invention is to provide a tablet personal computer, wherein through changing the external interface slots of the tablet personal computer from the bottom of the narrow side to the bottom of the right wide side, a bottom of the left wide side of the tablet personal computer will not be provided with the interface slots, which facilitates a right-hand user (in majority) to hold the tablet personal computer with a left hand and to operate with a right hand. On the contrary, the interface slots can be provided at a bottom of the left wide side, allowing a left-hand user to use conveniently a right hand to hold the tablet personal computer and to operate with a left hand.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional schematic view of the present invention.

FIG. 2 shows another three-dimensional schematic view of the present invention.

FIG. 3 shows a three-dimensional exploded view of the present invention and a dock.

FIG. 4 shows a three-dimensional schematic view of the present invention which is inserted horizontally in a dock base.

FIG. 5 shows a three-dimensional schematic view of a conventional tablet personal computer which is put horizontally on a sliding base.

### DETAILED DESCRIPTION OF THE PREFERRED EMBODIMENTS

The present invention is a tablet personal computer, including an e-book. The detailed description and technical contents of the present invention are disclosed below, using the tablet personal computer as an example.

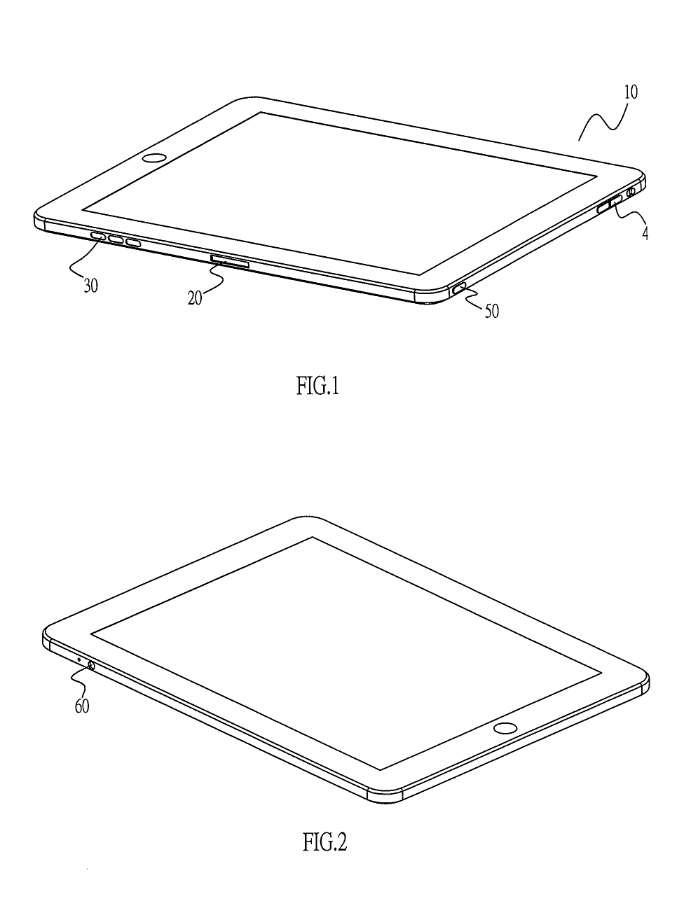

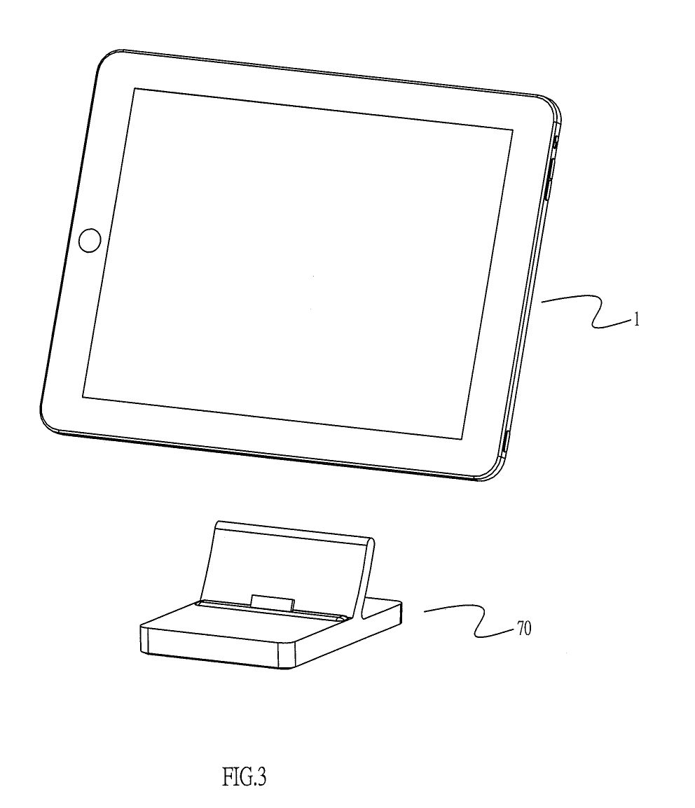

Referring to FIG. 1 and FIG. 2, it shows three-dimensional schematic views of the present invention. As shown in the drawings, the tablet personal computer or e-book 10 is provided with primary function keys and interface slots, including an interface slot 20 and a speaker hole 30 at a bottom of a right wide side, a volume control key 40 and a power key 50 at an upper narrow side, as well as an audio slot 60 at a left wide side.

When external interface slots are provided at the bottom of the right wide side of the tablet personal computer, a right-hand user can hold the tablet personal computer with a left hand and operate the tablet personal computer for use with a right hand. Whereas, when the external interface slots are provided at a bottom of a left wide side, a left-hand user can hold the tablet personal computer with a right hand and operate the tablet personal computer for use with a left hand.

Referring to FIG. 3, it shows an exploded view of the tablet personal computer or e-book 10 of the present invention, which is used with a dock base 70.

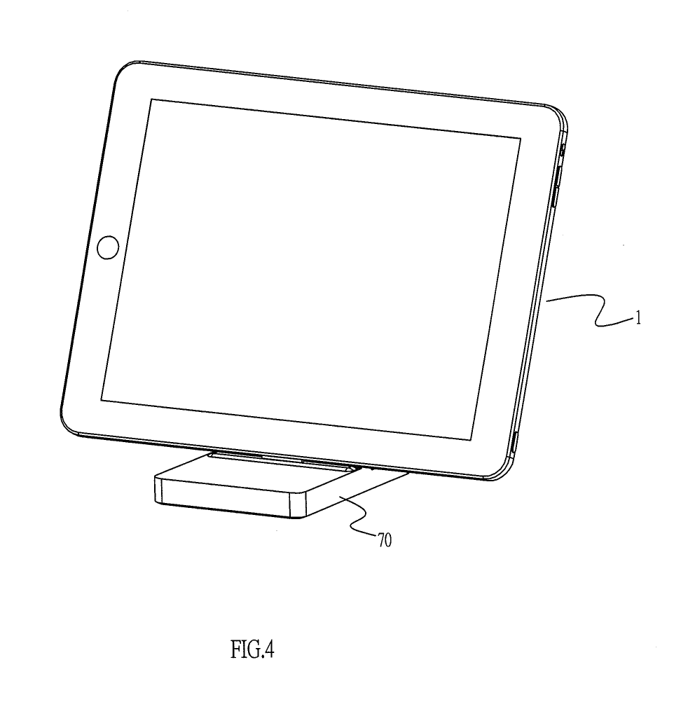

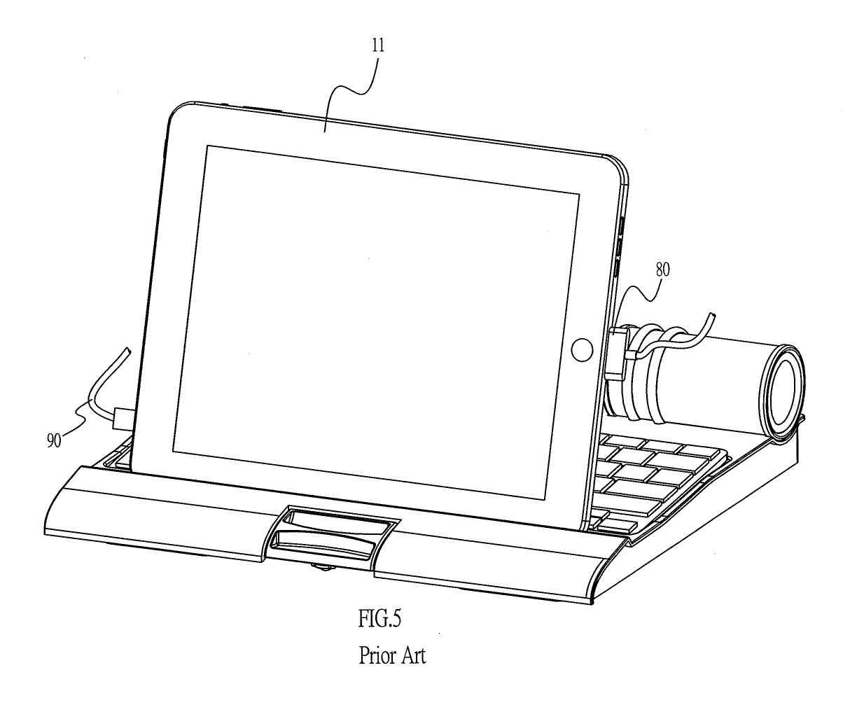

Referring to FIG. 4, it shows a three-dimensional schematic view of the tablet personal computer or e-book 10 of the present invention, which is inserted horizontally on the dock base 70, wherein through the interface slots provided on the dock base 70 and connection with interface transmission wires, a purpose of connecting with external equipment is achieved.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A tablet personal computer, including an e-book, comprising following function keys and slots:
an interface slot which is provided at a bottom of a wide side of the tablet personal computer to connect with external equipment;
a plurality speaker holes which are provided at a bottom of a right wide side of the tablet personal computer;
a volume control key which is provided at an upper narrow side of the tablet personal computer;
a power key which is provided at the upper narrow side of the tablet personal computer; and
an audio slot which is provided at a left wide side of the tablet personal computer.

2. The tablet personal computer according to claim 1, wherein external interface slots are provided at the bottom of the right wide side of the tablet personal computer that a right-hand user holds the tablet personal computer with a left hand and operates for use with a right hand.

3. The tablet personal computer according to claim 1, wherein external interface slots are provided at a bottom of a left wide side that a left-hand user holds the tablet personal computer with a right hand and operates for use with a left hand.

4. The tablet personal computer according to claim 1, wherein a user inserts the tablet personal computer horizontally on a dock base.

5. The tablet personal computer according to claim 1, wherein through interface slots provided on a dock base and connection with interface transmission wires, a purpose of connecting the tablet personal computer with external equipment is achieved.

6. The tablet personal computer according to claim 4, wherein through interface slots provided on a dock base and connection with interface transmission wires, a purpose of connecting the tablet personal computer with external equipment is achieved.
